(19) United States
(12) Patent Application Publication
(10) Pub. No.: US 2016/0125767 A1
(43) Pub. Date: May 5, 2016

(54) FOLDING THICK BOARD POSTER

(71) Applicant: POP THREE DIMENSIONAL PICTURE CO., LTD., New Taipei City (TW)

(72) Inventor: Richard LIN, New Taipei City (TW)

(21) Appl. No.: 14/639,090

(22) Filed: Mar. 4, 2015

(30) Foreign Application Priority Data
Nov. 3, 2014 (TW) 103219457

(51) Int. Cl. G09B 29/04

(52) U.S. Cl. CPC G09B 29/04

(57) ABSTRACT

A folding thick board poster includes a base unit, a first surface unit, a second surface unit and a first picture unit. The first picture unit includes four rectangular blocks connected by folding portions equipped on the first surface unit and the second surface unit. The folding thick board poster can be folded into a small size as a book so as to be easily carried.

### RELATED APPLICATIONS

This application claims priority to Taiwanese Application Serial Number 103219457, filed Nov. 3, 2014, which is herein incorporated by reference.

### BACKGROUND

1. Field of Invention

The invention relates to a poster, and particularly to a folding thick board poster.

2. Description of Related Art

A poster can conveniently display charts, graphs, pictures, illustrations and any other content thereon to the viewers.

Base on the thickness of the posters, the posters can be divided into two types, e.g. a thin board poster and a thick board poster. The thin board posters can be wound into a cylinder for easy transportation. However, while a thin board poster is demonstrated, the thin board poster provides poor stability because the edges of the thin board poster are often curved, and cannot show a complete and smooth surface for the viewers. In addition, although the thin board poster may be wound into a cylinder, but the length of the thin board poster cannot be shortened, resulting in the thin poster carried inconveniently.

The thick board poster can relatively show a full and smooth surface and the surface of the thick board poster provides good stability. However, the conventional thick board poster cannot be folded or wound so that the conventional thick board is inconveniently carried.

### SUMMARY

The invention provides a folding thick board poster, which has the advantage of good stability for the poster surface and good portability.

According to an aspect of the invention, a folding thick board poster includes a base unit, a first surface unit, a second surface unit, and a first picture unit. The base unit has a first rectangular base board located at the top right position, a second rectangular base board located at the bottom right position, a third rectangular base board located at the bottom left position and a fourth rectangular base board located at the top left position, the base unit further having a front side and a back side opposite to the front side. The first surface unit has a first rectangular portion located at the top right position, a second rectangular portion located at the bottom right position, a third rectangular portion located at the bottom left position and a fourth rectangular portion located at the top left position separately adhered to the front side of the first rectangular base board, the second rectangular base board, the third rectangular base board and the fourth rectangular base board, and the second rectangular portion is connected to the third rectangular portion to form a second folding portion. The second surface unit has a first rectangular area located at the top right position, a second rectangular area located at the bottom right position, a third rectangular area located at the bottom left position and a fourth rectangular area located at the top left position separately adhered to the back side of the first rectangular base board, the second rectangular base board, the third rectangular base board and the fourth rectangular base board, the first rectangular area connected to the second rectangular area to form a first folding portion, the third rectangular area connected to the fourth rectangular area to form a third folding portion. The first picture unit has a first pattern located at the top right position, a second pattern located at the bottom right position, a third pattern located at the bottom left position and a fourth pattern located at the top left position be separately drawn on the surfaces of the first rectangular portion, the second rectangular portion, the third rectangular portion and the fourth rectangular portion of the first surface unit.

According to an embodiment of the invention, the first pattern is adjacent to the second pattern and the fourth pattern, and the third pattern is adjacent to the second pattern and the fourth pattern.

According to an embodiment of the invention, the first surface unit is covered by a first transparent film, and the first transparent film covers on the first picture unit.

According to an embodiment of the invention, the folding thick board poster further has a second picture unit. The second picture unit has a fifth pattern located at the top right position, a sixth pattern located at the bottom right position, a seventh pattern located at the bottom left position and an eighth pattern located at the top left position be separately drawn on the surfaces of the first rectangular area, the second rectangular area, the third rectangular area and the fourth rectangular area of the second surface unit.

According to an embodiment of the invention, the fifth pattern is adjacent to the sixth pattern and the eighth pattern, the seventh pattern is adjacent to the sixth pattern and the eighth pattern.

According to an embodiment of the invention, the second surface unit is covered by a second transparent film and the second transparent film covers on the second picture unit.

According to an embodiment of the invention, the second rectangular base board, the second rectangular portion, the second rectangular area, the third rectangular base board, the third rectangular portion and the third rectangular area respectively have an arc indentation at the corresponding peripheral.

According to an embodiment of the invention, the first rectangular base board, the first rectangular portion, the first rectangular area, the fourth rectangular base board, the fourth rectangular portion and the fourth rectangular area respectively have a through hole at the corresponding top position.

The folding thick board poster according to one embodiment of the present invention can provide good stability for the poster surface and good portability, and user can fold the folding thick board poster to a small sized book to easily carry the folded thick board poster.

### BRIEF DESCRIPTION OF THE DRAWINGS

FIG. 1 is an unfolded perspective view of the folding thick board poster according to an embodiment of the invention.

FIG. 2 is an exploded view of the folding thick board poster of FIG. 1.

FIG. 3 is a schematically perspective view of the folding thick board poster of FIG. 1 under folding.

FIG. 4 is a partially enlarged view of part A of the schematically perspective view of the folding thick board poster of FIG. 3.

FIG. 5 is a partially enlarged view of part B of the schematically perspective view of the folding thick board poster of FIG. 3.

FIG. 6 is an unfold perspective view of the folding thick board poster according to an embodiment of the invention.

### DESCRIPTION OF THE EMBODIMENTS

The foregoing and other technical contents, features and functions of the invention will be clearly presented through the following detailed description of embodiments with reference to the accompanying drawings.

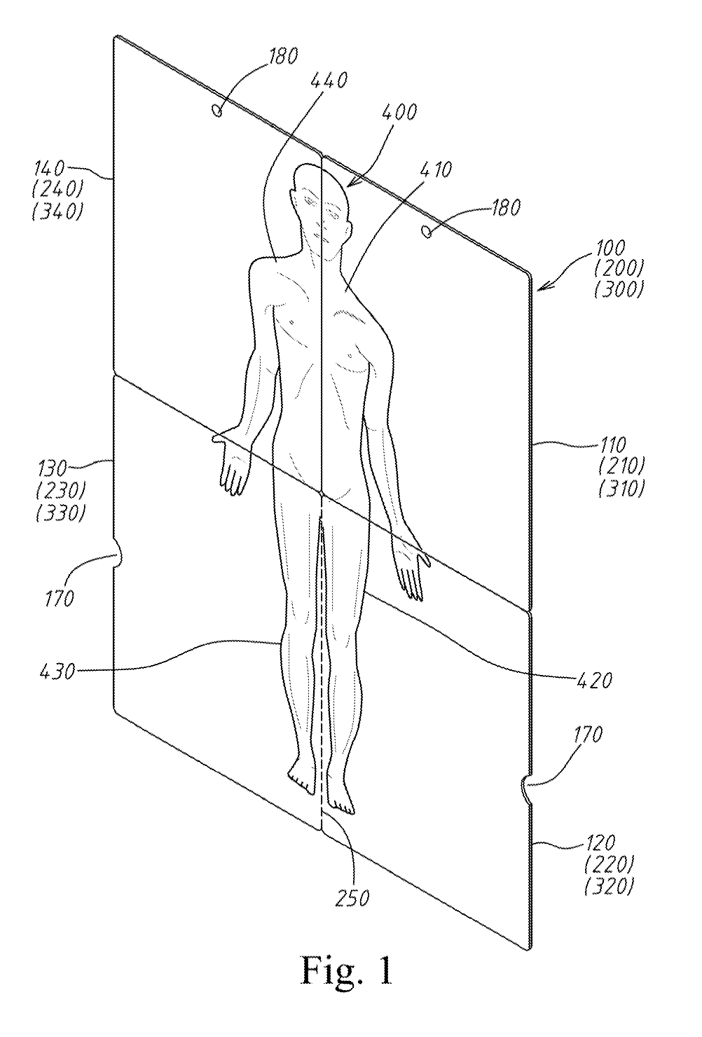

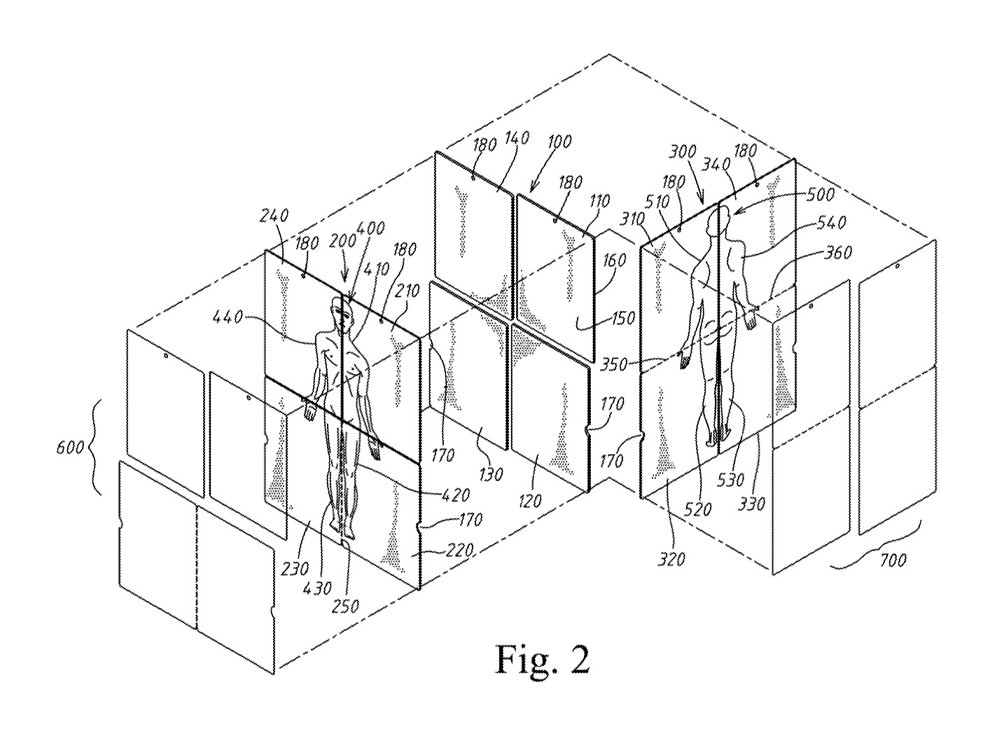

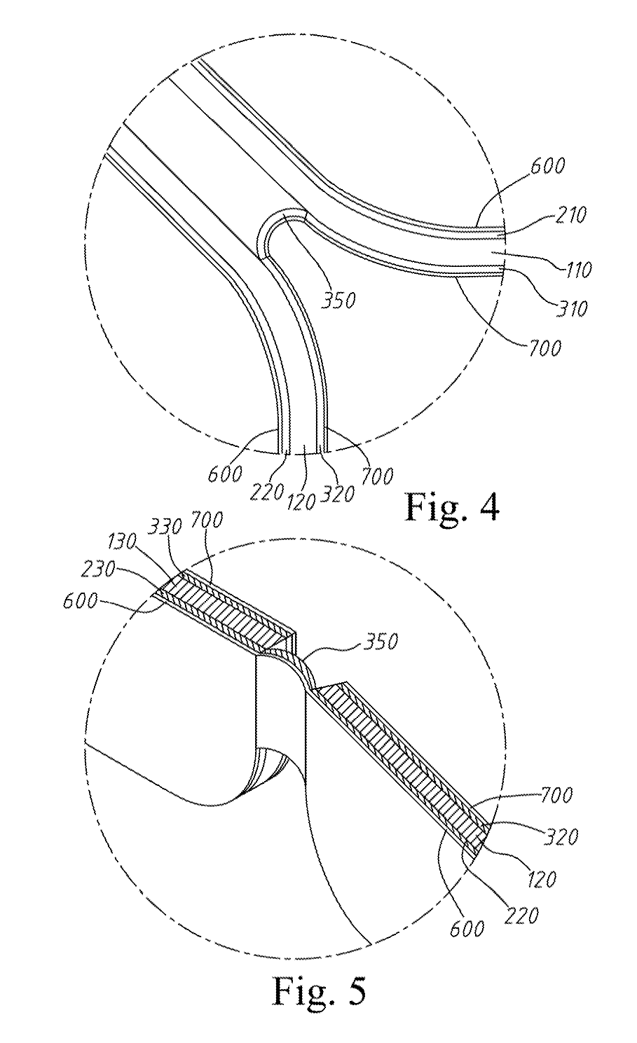

Referring to FIGS. 1-6, a folding thick board poster according to an embodiment of the invention has a base unit 100, a first surface unit 200, a second surface unit 300, a first picture unit 400, a second picture unit 500, a first transparent film 600 and a second transparent film 700.

The base unit 100 has a first rectangular base board 110 located at the top right position, a second rectangular base board 120 located at the bottom right position, a third rectangular base board 130 located at the bottom left position and a fourth rectangular base board 140 located at the top left position, and these rectangular base board are separately with each other. The base unit 100 has a front side 150 and a back side 160 opposite to the front side 150.

The first surface unit 200 has a first rectangular portion 210 located at the top right position, a second rectangular portion 220 located at the bottom right position, a third rectangular portion 230 located at the bottom left position and a fourth rectangular portion 240 located at the top left position. The first rectangular portion 210, the second rectangular portion 220, the third rectangular portion 230, and the fourth rectangular portion 240 are respectively adhered to the front sides 150 of the first rectangular base board 110, the second rectangular base board 120, the third rectangular base board 130 and the fourth rectangular base board 140. The second rectangular portion 220 is connected to the third rectangular portion 230 to form a second folding portion 250.

A first picture unit 400 is drawn on the surface of the first surface unit 200. The first picture unit 400 includes a first pattern 410 located at the top right position, a second pattern 420 located at the bottom right position, a third pattern 430 located at the bottom left position, and a fourth pattern 440 located at the top left position. The first pattern 410, the second pattern 420, the third pattern 430, and the fourth pattern 440 are respectively drawn on the surfaces of the first rectangular portion 210, the second rectangular portion 220, the third rectangular portion 230 and the fourth rectangular portion 240 of the first surface unit 200. The first pattern 410, the second pattern 420 and the fourth pattern 440 are consecutive, and the third pattern 430, the second pattern 420 and the fourth pattern 440 are consecutive to form a large-sized picture.

A first transparent film 600 is coated on the surface of the first surface unit 200 and covers on the first picture unit 400. The first transparent film 600 does not influence on watching the first picture unit 400, and allow a marker pen to write thereon and easily wiping the mark therefrom.

The front side 150 of the base unit 100 has a first picture unit 400, and the back side 160 of the base unit 100 further has a second picture unit 500 so that the front side and the back side of the poster have different pictures. That is to say, the back side 160 of the base unit 100 has a second surface unit 300 and the second picture unit 500. The second surface unit 300 has a first rectangular area 310 located at the top right position, a second rectangular area 320 located at the bottom right position, a third rectangular area 330 located at the bottom left position and a fourth rectangular area 340 located at the top left position. The first rectangular area 310, the second rectangular area 320, the third rectangular area 330 and the fourth rectangular area 340 are respectively adhered to the back sides 160 of the first rectangular base board 110, the second rectangular base board 120, the third rectangular base board 130 and the fourth rectangular base board 140. In addition, the first rectangular area 310 is connected to the second rectangular area 320 to form a first folding portion 350, and the third rectangular area 330 is connected to the fourth rectangular area 340 to form a third folding portion 360.

Similarly, the surface of the second surface unit 300 is drawn a second picture unit 500. The second picture unit 500 has a fifth pattern 510 located at the top right position, a sixth pattern 520 located at the bottom right position, a seventh pattern 530 located at the bottom left position, and an eighth pattern 540 located at the top left position. The fifth pattern 510, the sixth pattern 520, the seventh pattern 530 and the eighth pattern 540 are respectively drawn on surfaces of the first rectangular area 310, the second rectangular area 320, the third rectangular area 330 and the fourth rectangular area 340 of the second surface unit 300. The fifth pattern 510, the sixth pattern 520 and the eighth pattern 540 are consecutive, and the seventh pattern 530, the sixth pattern 520 and the eighth pattern 540 are consecutive to form a large-sized picture.

The foregoing first picture unit 400 and the second picture unit 500 can be any picture or any text, for example, a human organs picture and commentary text to explain the picture.

Similarly, a second transparent film 700 is coated on the surface of the second surface unit 300 and covers on the second picture unit 500. The second transparent film 700 has the same function as the first transparent film 600.

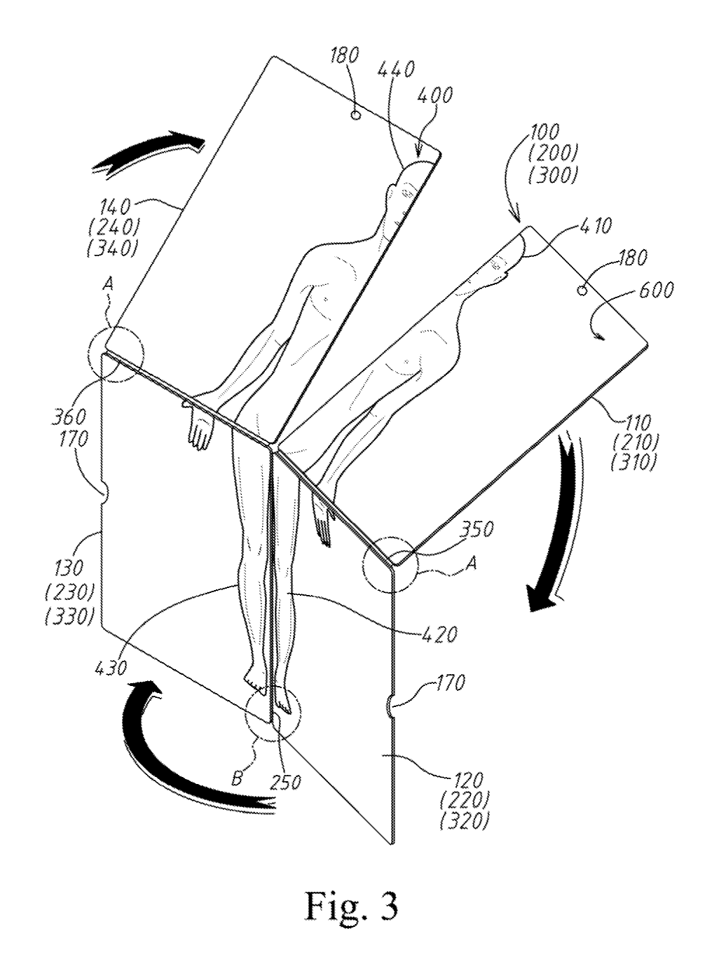

Further referring to FIG. 3, while folding the poster, the first rectangular base board 110 of the base unit 100 together with the first rectangular portion 210 of the first surface unit 200 and the first rectangular area 310 of the second surface unit 300 is folded toward the back side 160 of the base unit 100 along the first folding portion 350 function as a folding axle. Subsequently, the fourth rectangular base board 140 of the base unit 100 together with the fourth rectangular portion 240 of the first surface unit 200 and the fourth rectangular area 340 of the second surface unit 300 is folded toward the back side 160 of the base unit 100 along the third folding portion 360 function as a folding axle. In addition, the second rectangular base board 120 of the base unit 100 together with the second rectangular portion 220 of the first surface unit 200 and the second rectangular area 320 of the second surface unit 300 toward the third rectangular base board 130 of the base unit 100 along the second folding portion 250 function as a folding axle. Hence, the entire folding thick board poster can be folded into a rectangular book size stacked by four rectangular blocks so as to be easily carried.

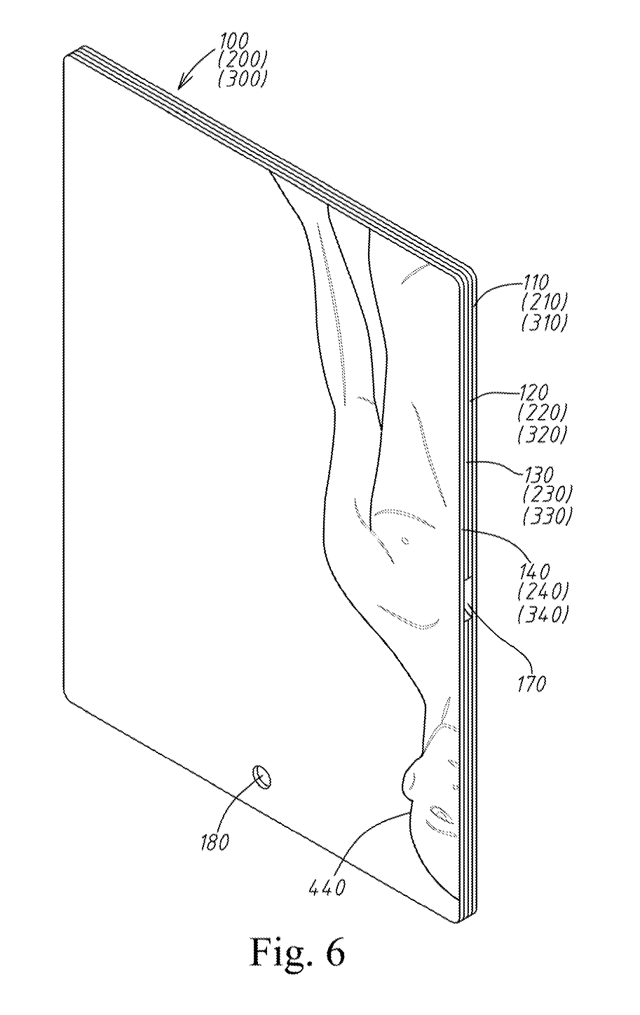

The second rectangular base board 120 as well as the second rectangular portion 220 and the second rectangular area 320, and the third rectangular base board 130 as well as the third rectangular portion 230 and the third rectangular area 330 respectively have an arc indentation 170 at the corresponding peripheral. When the folding thick board poster is folded into a rectangular book as shown in FIG. 6, the arc indentation 170 is hidden between the edges of the first rectangular base board 110 and the fourth rectangular base board 140. The arc indentation 170 can allow the user's finger easily entering into the arc indentation 170 to open the folding thick board poster.

While unfolding the poster, the user can reverse the processes according to the foregoing description of FIG. 3 to demonstrate the large-sized poster as demonstrating in FIG. 1. The unfolded thick board poster can provide a good stability for the poster surface and good portability.

The first rectangular base board 110 as well as the first rectangular portion 210 and the first rectangular area 310, and the fourth rectangular base board 140 as well as the fourth rectangular portion 240 and the fourth rectangular area 340 are respectively formed a through hole 180 at an corresponding top portion thereof to allow the unfolded thick board poster being hanged on a wall so as to easily see the content thereon for the user.

The folding thick board poster according to one embodiment of the present invention can provide a good stability for the poster surface and good portability, and can be folded to a small sized book so as to be easily carried.

Although the invention has been disclosed with reference to the above embodiments, these embodiments are not intended to limit the invention. It will be apparent to those of skills in the art that various modifications and variations can be made without departing from the spirit and scope of the invention. Therefore, the scope of the invention shall be defined by the appended claims.

What is claimed is:

1. A folding thick board poster, comprising:
a base unit having a first rectangular base board located at the top right position, a second rectangular base board located at the bottom right position, a third rectangular base board located at the bottom left position and a fourth rectangular base board located at the top left position, the base unit further having a front side and a back side opposite to the front side;
a first surface unit having a first rectangular portion located at the top right position, a second rectangular portion located at the bottom right position, a third rectangular portion located at the bottom left position and a fourth rectangular portion located at the top left position separately adhered to the front sides of the first rectangular base board, the second rectangular base board, the third rectangular base board and the fourth rectangular base board, and the second rectangular portion is connected to the third rectangular portion to form a second folding portion;
a second surface unit having a first rectangular area located at the top right position, a second rectangular area located at the bottom right position, a third rectangular area located at the bottom left position and a fourth rectangular area located at the top left position separately adhered to the back side of the first rectangular base board, the second rectangular base board, the third rectangular base board and the fourth rectangular base board, the first rectangular area connected to the second rectangular area to form a first folding portion, the third rectangular area connected to the fourth rectangular area to form a third folding portion; and
a first picture unit having a first pattern located at the top right position, a second pattern located at the bottom right position, a third pattern located at the bottom left position and a fourth pattern located at the top left position be separately drawn on the surfaces of the first rectangular portion, the second rectangular portion, the third rectangular portion and the fourth rectangular portion of the first surface unit.

2. The folding thick board poster of claim 1, wherein the first pattern is adjacent to the second pattern and the fourth pattern, and the third pattern is adjacent to the second pattern and the fourth pattern.

3. The folding thick board poster of claim 1, wherein the first surface unit is covered by a first transparent film, and the first transparent film covers the first picture unit.

4. The folding thick board poster of claim 1, further comprising a second picture unit, wherein the second picture unit has a fifth pattern located at the top right position, a sixth pattern located at the bottom right position, a seventh pattern located at the bottom left position and an eighth pattern located at the top left position be separately drawn on the surfaces of the first rectangular area, the second rectangular area, the third rectangular area and the fourth rectangular area of the second surface unit.

5. The folding thick board poster of claim 2, further comprising a second picture unit, wherein the second picture unit has a fifth pattern located at the top right position, a sixth pattern located at the bottom right position, a seventh pattern located at the bottom left position and an eighth pattern located at the top left position be separately drawn on the surfaces of the first rectangular area, the second rectangular area, the third rectangular area and the fourth rectangular area of the second surface unit.

6. The folding thick board poster of claim 3, further comprising a second picture unit, wherein the second picture unit has a fifth pattern located at the top right position, a sixth pattern located at the bottom right position, a seventh pattern located at the bottom left position and an eighth pattern located at the top left position be separately drawn on the surfaces of the first rectangular area, the second rectangular area, the third rectangular area and the fourth rectangular area of the second surface unit.

7. The folding thick board poster of claim 4, wherein the fifth pattern is adjacent to the sixth pattern and the eighth pattern, the seventh pattern is adjacent to the sixth pattern and the eighth pattern.

8. The folding thick board poster of claim 5, wherein the fifth pattern is adjacent to the sixth pattern and the eighth pattern, the seventh pattern is adjacent to the sixth pattern and the eighth pattern.

9. The folding thick board poster of claim 6, wherein the fifth pattern is adjacent to the sixth pattern and the eighth pattern, the seventh pattern is adjacent to the sixth pattern and the eighth pattern.

10. The folding thick board poster of claim 7, wherein the second surface unit is covered by a second transparent film and the second transparent film covers on the second picture unit.

11. The folding thick board poster of claim 8, wherein the second surface unit is covered by a second transparent film and the second transparent film covers on the second picture unit.

12. The folding thick board poster of claim 9, wherein the second surface unit is covered by a second transparent film and the second transparent film covers on the second picture unit.

13. The folding thick board poster of claim 1, wherein the second rectangular base board, the second rectangular portion, the second rectangular area, the third rectangular base board, the third rectangular portion and the third rectangular area respectively have an arc indentation at the corresponding peripheral.

14. The folding thick board poster of claim 1, wherein the first rectangular base board, the first rectangular portion, the first rectangular area, the fourth rectangular base board, the fourth rectangular portion and the fourth rectangular area respectively have a through hole at the corresponding top position.
